(19) United States
(12) Patent Application Publication
(10) Pub. No.: US 2014/0346104 A1
(43) Pub. Date: Nov. 27, 2014

(54) CERAMIC FILTER ELEMENT AND METHOD FOR MANUFACTURING A CERAMIC FILTER ELEMENT

(71) Applicant: Outotec (Filters) Oy, Lappeenranta (FI)

(72) Inventors: Bjarne Ekberg, Turku (FI); Olli Högnabba, Kantvik (FI); Rolf Hindstöm, Turku (FI); David Eveland, Bloomfield, NY (US); Edward Vroman, New York, NY (US)

(73) Assignee: Outotec (Filters) Oy, Lappeenranta (FI)

(21) Appl. No.: 13/898,693

(22) Filed: May 21, 2013

(51) Int. Cl. B01D 29/01

(52) U.S. Cl. CPC B01D 29/012
USPC 210/323.1; 210/490; 427/202; 427/205

(57) ABSTRACT

The invention relates to a ceramic filter element (22) for removal of liquid from solids containing material in a capillary suction dryer. The filter element comprises a ceramic substrate covered by a sintered ceramic microporous layer (31). The sintered microporous membrane layer is provided with coarse solid particles (71) of a particle size larger than a pore size of the membrane material layer (31) so as to form a textured surface (50) which prevents a filter cake from sliding off the surface of the filter element prior to the intended cake discharge.

### FIELD OF THE INVENTION

The present invention relates generally to ceramic filter elements.

### BACKGROUND OF THE INVENTION

Filtration is a widely used process whereby a slurry or solid liquid mixture is forced through a media, with the solids retained on the media and the liquid phase passing through. This process is generally well understood in the industry. Examples of filtration types include depth filtration, pressure and vacuum filtration, and gravity and centrifugal filtration.

Both pressure and vacuum filters are used in the dewatering of mineral concentrates. The principal difference between pressure and vacuum filters is the way the driving force for filtration is generated. In pressure filtration, overpressure within the filtration chamber is generated with the help of e.g. a diaphragm, a piston, or external devices, e.g. a feed pump. Consequently, solids are deposited onto the filter medium and filtrate flows through into the filtrate channels. Pressure filters often operate in batch mode because continuous cake discharge is more difficult to achieve.

The cake formation in vacuum filtration is based on generating suction within the filtrate channels. Several types of vacuum filters exist, ranging from belt filters to rotary vacuum drum filters and rotary vacuum disc filters.

Rotary vacuum disc filters are used for filtering suspensions on a large scale, such as the dewatering of mineral concentrates. The dewatering of mineral concentrates requires large capacity in addition to producing a cake with low moisture content. Such large processes are commonly energy intensive and means to lower the specific energy consumption are needed. The vacuum disc filter may comprise a plurality of filter discs arranged in line co-axially around a central pipe or shaft. Each filter disc may be formed of a number of individual filter sectors, called filter plates, that are mounted circumferentially in a radial plane around the central pipe or shaft to form the filter disc, and as the shaft is fitted so as to revolve, each filter plate or sector is, in its turn, displaced into a slurry basin and further, as the shaft of rotation revolves, rises out of the basin. When the filter medium is submerged in the slurry basin where, under the influence of the vacuum, the cake forms onto the medium. Once the filter sector or plate comes out of the basin, the pores are emptied as the cake is deliquored for a predetermined time which is essentially limited by the rotation speed of the disc. The cake can be discharged by a back-pulse of air or by scraping, after which the cycle begins again.

In a rotary vacuum drum filter, filter elements, e.g. filter plates, are arranged to form an essentially continuous cylindrical shell or envelope surface, i.e. a filter drum. The drum rotates through a slurry basin and the vacuum sucks liquid and solids onto the drum surface, the liquid portion is “sucked” by the vacuum through the filter media to the internal portion of the drum, and the filtrate is pumped away. The solids adhere to the outside of the drum and form a cake. As the drum rotates, the filter elements with the filter cakes rise out of the basin, the cakes are dried and removed from the surface of the drum.

The most commonly used filter media for vacuum filters are polymeric filter cloths and filter elements of ceramic membranes. Whereas the use of a cloth filter medium requires heavy duty vacuum pumps, due to vacuum losses through the cloth during cake deliquoring, the ceramic filter medium, when wetted, does not allow air to pass through and enables the use of smaller vacuum pumps and, consequently, yields significant energy savings. U.S. Pat. No. 7,521,012 B2 (EP1755870) discloses a method for the manufacture of a composite filter plate. After completion of the substantially flat filter plate 10, further steps can be taken, for example, to either provide additional functionality and/or further render the filter plate more amenable to subsequent additional assembly into a larger filtration device. Such steps can include, for example, the drilling of ports through the filter plate, the addition of flow distributors and flow paths; the removal of burrs, sprue, and/or other like unwanted residual molding waste; surface application of hydrophobic or hydrophilic coatings; surface polishing or roughening; autoclaving, steam sterilization, or other sanitizing chemical treatment; and packaging.

In some filtering applications, such as iron ore applications, the filter cake tends to be detached from the filter plate too early due to the weight of the cake and low differential pressure over the filter cake.

### BRIEF DESCRIPTION OF THE INVENTION

An aspect of the present invention is to mitigate the problem relating to a premature detachment of the filter cake. Aspects of the invention is achieved by a method, a filter element and an apparatus according to the independent claims. Embodiments of the invention are disclosed in the dependent claims.

An aspect of the invention is a method for manufacturing a filter element to be used in removal of liquid from solids containing material to be dried in a capillary suction dryer which filter element contains a ceramic microporous layer supported by a ceramic substrate, wherein the method comprises:

providing the ceramic substrate,

coating the ceramic substrate by a ceramic microporous material layer,

applying solid particles to the membrane material layer, a particle size of the solid particles being larger than a pore size of the membrane material layer, and

sintering the ceramic microporous membrane material containing the solid particles.

In an embodiment, the coating comprises dipping the ceramic substrate into into a ceramic slurry to form the microporous ceramic membrane

In an embodiment in combination with any preceding embodiment, the applying comprises spraying the solid particles on the ceramic microporous layer.

In an embodiment in combination with any preceding embodiment, the solid particles comprise alumina particles.

In an embodiment in combination with any preceding embodiment, the method comprises setting a size of the solid particles and/or a desired particle density on the ceramic microporous membrane, according to a desired friction effect.

In an embodiment in combination with any preceding embodiment, the particle size is in the range of 10 micrometers . . . 800 micrometers, preferably in the range of 40 . . . 300 micrometers.

In an embodiment in combination with any preceding embodiment, an average particle density on the membrane material is in the range approximately 50 . . . 250 particles/square centimeter.

Another aspect of the invention is a filter element to be used in removal of liquid from solids containing material to be dried in a capillary suction dryer, the filter element comprising a ceramic substrate covered by a sintered ceramic microporous layer, wherein the sintered microporous membrane layer contains coarse solid particles of a particle size larger than a pore size of the membrane material layer.

Still another aspect of the invention is a filter apparatus comprising one or more filter elements according to embodiments of the invention.

### BRIEF DESCRIPTION OF THE DRAWINGS

In the following the invention will be described in greater detail by means of example embodiments with reference to the accompanying drawings, in which

FIG. 1 is a perspective top view illustrating an exemplary disc filter apparatus, wherein embodiments of the invention may be applied;

FIG. 2 is a perspective top view of an exemplary sector-shaped ceramic filter plate;

FIGS. 3A, 3B and 3C illustrate exemplary structures of a ceramic filter plate wherein embodiments of the invention may be applied;

FIGS. 4A, 4B and 4C illustrate different phases of a filtering cycle;

FIG. 5A illustrates a filter plate provided with a coarse textured surface 50 according to exemplary embodiment of the invention;

FIG. 5B is a photograph illustrating a zoomed-in portion of a textured surface 50 of a real ceramic filter plate 22;

FIG. 5C is another photograph illustrating a further zoomed-in portion of a textured surface 50;

FIG. 6A illustrates an exemplary monobody substrate according to an embodiment;

FIG. 6B illustrates a cross-sectional top view of the substrate shown in FIG. 6A;

FIGS. 7A, 7B and 7C illustrate phases of a dip coating process; and

FIG. 7D illustrates an example of spraying 71 solid particles on the membrane surface after the membrane dip coating.

### DESCRIPTION OF EXEMPLARY EMBODIMENTS

Principles of the invention can be applied for drying or dewatering fluid materials in any industrial processes, particularly in mineral and mining industries. In embodiments described herein, a material to be filtered is referred to as a slurry, but embodiments of the invention are not intended to be restricted to this type of fluid material. The slurry may have high solids concentration, e.g. base metal concentrates, iron ore, chromite, ferrochrome, copper, gold, cobalt, nickel, zinc, lead and pyrite. In the following, example embodiments of filter plates for rotary vacuum disc filters are illustrated but the principles of the invention can be applied also for filter media of other types of vacuum filters, such as rotary vacuum drum filters.

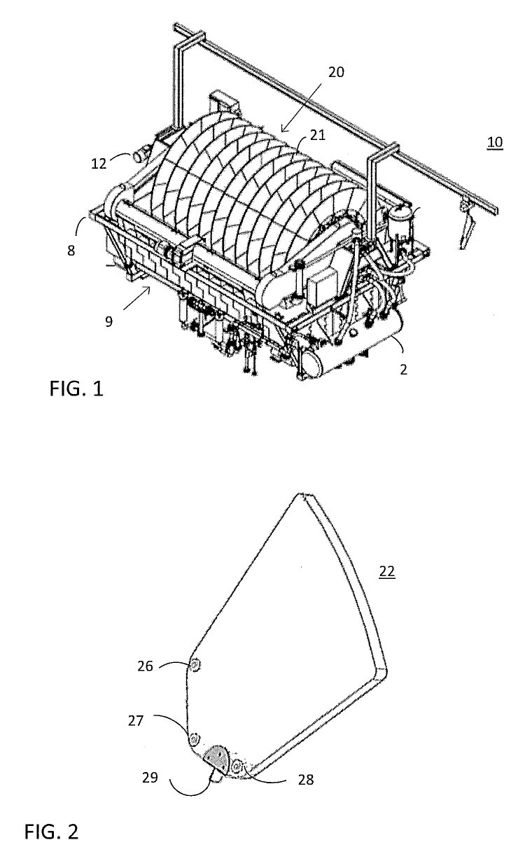

FIG. 1 is a perspective top view illustrating an exemplary disc filter apparatus in which filter plates according to embodiments of the invention may be applied. The exemplary disc filter apparatus 10 comprises a cylindrical-shaped drum 20 that is supported by bearings on a frame 8 and rotatable about the longitudinal axis of the drum 20 such that the lower portion of the drum is submerged in a slurry basin 9 located below the drum 20. A drum drive 12 (such as an electric motor, a gear box) is provided for rotating the drum 20. The drum 20 comprises a plurality of ceramic filter discs 21 arranged in line co-axially around the central axis of the drum 20. For example, the number of the ceramic filter discs may range from 2 to 20. The diameter of each disc 21 may be large, ranging from 1,5 m to 4 m, for example. Examples of commercially available disc filters in which embodiments of the invention may be applied, include Outotec Larox CC filters, models CC-6, CC-15, CC-30, CC-45, CC-60, CC-96 and CC-144 manufactured by Outotec Oyj.

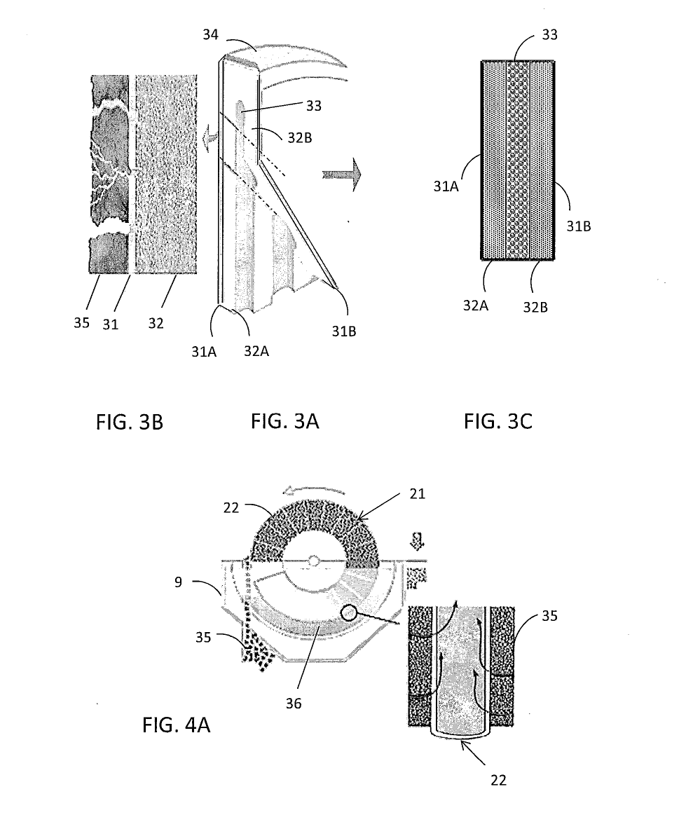

Each filter disc 21 may be formed of a number of individual sector-shaped ceramic filter elements, called filter plates, that are mounted in a radial planar array around the central axis of the drum to form an essentially continuous and planar disc surface. The number of the filter plates may be 12 or 15, for example. FIG. 2 is a perspective top view of an exemplary sector-shaped ceramic filter plate. The filter plate 22 may be provided with mounting parts, such as fastening hubs 26, 27 and 28 which function as means for attaching the plate 22 to mounting means in the drum. FIGS. 3A, 3B and 3C illustrate exemplary structures of a ceramic filter plate wherein embodiments of the invention may be applied. A microporous filter plate 22 may comprise a first suction structure 31A, 32A and an opposed second suction structure 31B, 32B. The first suction structure comprises a microporous membrane 31A and a ceramic substrate 32A, whereon the membrane 31A is positioned. Similarly, the second suction wall comprises a microporous membrane 31B and a ceramic substrate 32B. An interior space 33 is defined between the opposed first and second suction structure 31A, 32A and 31B, 32B resulting in a sandwich structure. The filter plate 22 may also be provided with connecting part 29, such as a filtrate tube or a filtrate nozzle, for convergence of fluids. The interior space 33 provides a flow channel or channels which will have a flow connection with collecting piping in the drum 20, e.g. by means of a tube connector 29. When the collecting pipe is connected to a vacuum pump, the interior 33 of the filter plate 22 is maintained at a negative pressure, i.e. a pressure difference is maintained over the suction wall. The membrane 31 contains micropores that create strong capillary action in contact with water. The pore size of the microporous membrane 31 is preferably in the range of 0.2 to 5 micrometer and that will make possible that only liquid is flowed through the microporous layer. The interior space '33 may be an open space or it may be filled with a granular core material which acts as a reinforcement for the structure of the plate. Due to its large pore size and high volume fraction of porosity, the material does not prevent the flow of liquid that enters into the central interior space 33. The interior space 33 may further comprise supporting elements or partition walls to further reinforce the structure of the plate 22. The edges 34 of the plate may be sealed by means of painting or glazing or another suitable means to seal, thus preventing flow through the edges.

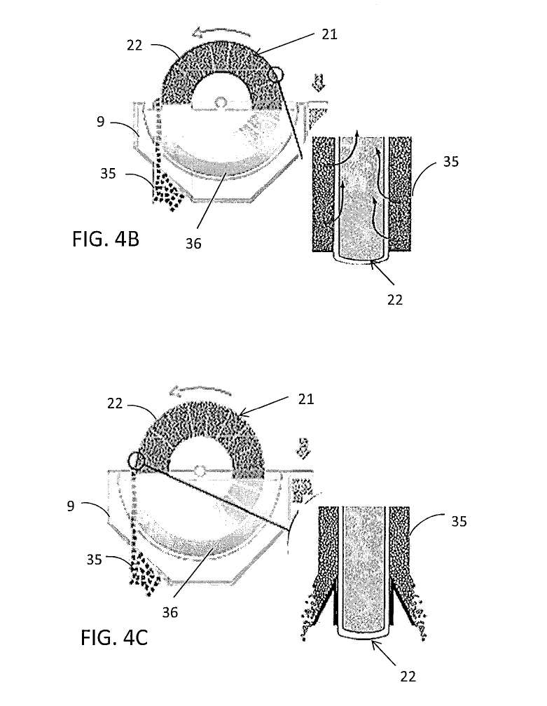

In exemplary embodiments the filter plates 22 of the consecutive discs are disposed in rows, each row establishing a sector or zone of the disc 21. As the row of the filter discs 21 rotate, the plates 22 of the each disc 22 move into and through the basin 9. Thus, each filter plate 22 goes through four different process phases or sectors during one rotation of the disc 21. In a cake forming phase, a partial vacuum is transmitted to the filter plates 22 and filtrate is drawn through the ceramic plate 22 as it is immersed into the slurry basin 9, and a cake 35 forms on the surface of the plate 22. The liquid or filtrate in the central interior space 33 is then transferred into the collecting pipe and further out of the drum 20. The plate 22 enters the cake drying phase (illustrated in FIG. 4B) after it leaves the basin 9. A partial vacuum or overpressure is maintained in the filter plates 22 also during the drying phase so as to draw more filtrate from the cake 35 and to keep the cake 35 on the surface of the filter plate 35. If cake washing is required, it is done in the beginning of the drying phase. In the cake discharge phase illustrated in FIG. 4C, the cake 35 is scraped off by ceramic scrapers so that a thin cake is left on the plate 22 (gap between the scraper and the plate 22). After the cake discharge, in a cleaning phase (commonly called a backwash or backflush phase) of sector of each rotation, water or filtrate is pumped with overpressure in a reverse direction through the plate 22 to wash off the residual cake and clean the pores of the filter plate.

In some filtering applications, such as iron ore applications, the filter cake tends to be detached from the filter plate too early due to the weight of the cake and a low differential pressure over the filter cake. More specifically, the iron ore filter cake may slip off from the surface of the filter plate 22 during the drying phase before the actual intended cake discharge.

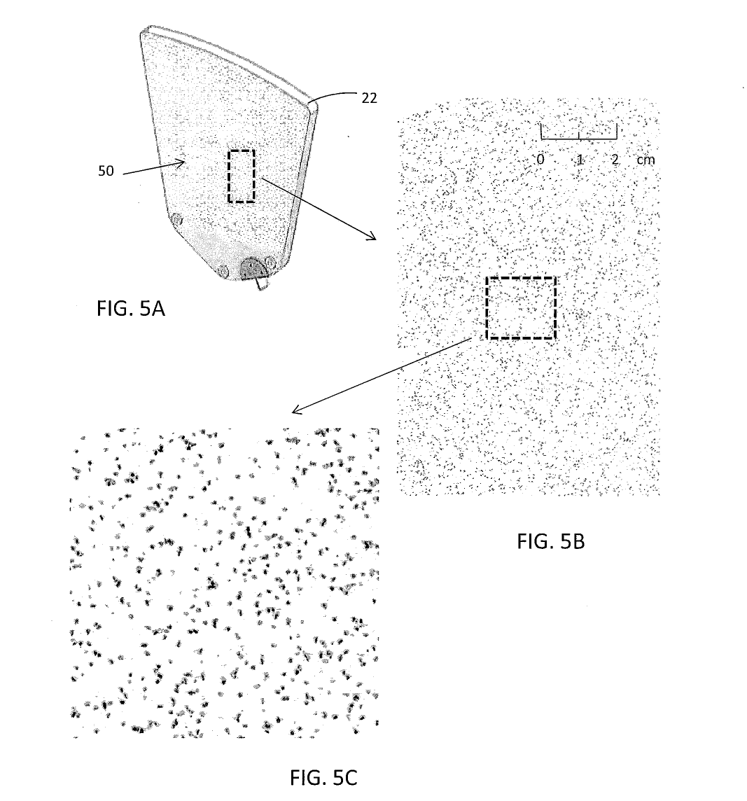

According to an aspect of the invention, a sintered ceramic microporous membrane material of a ceramic filter plate contains coarse solid particles to effectively increase the area of the contact between the filter plate and the cake, to increase friction and adhesion between the cake and the filter plate and to thereby prevent the filter cake from sliding off the surface of the filter plate prior to the intended cake discharge. The solid particles provide a coarse textured surface 50 for the filter plate 22, as illustrated in FIGS. 5A, 5B and 5C. The appearance of the surface is like “sand paper”. The friction of the textured surface is high and it prevents the filter cake from falling off the filter plate. FIG. 5B is a photograph illustrating a zoomed-in portion of a textured surface 50 of a real ceramic filter plate 22. FIG. 5C is another photograph illustrating a further zoomed-in portion of a textured surface 50.

In an embodiment, the solid particles comprise alumina (Al2O3) particles. However, also other type of particles than alumina can be used. Criteria for the selection of the material may be that the particles should not melt or change the chemistry of the membrane during firing or otherwise disturb the manufacturing process.

The size of the solid particles has an effect on the increase in friction and adhesion between the cake and the filter plate. The particle size of the solid particles is larger than a pore size of the membrane material layer. The particle size may be at least two times larger than the pore size, preferably more than ten times larger than the pore size. The size of particles may be selected dependent on the application where the filter plates are used. In typical applications, the particle size used may be in the range of 40-300 micrometers (microns). In some applications, a very small increase in friction in membrane may be enough to avoid the problem with falling filter cakes. For this kind of applications the particle size may be 10-100 micrometers. In applications with large iron ore particles in the range of 0.5 . . . 1.5 millimeters and filter cakes with high mass, the friction of the membrane must be increased significantly and the grit spraying using particles in the range of 0.2 . . . 0.8 millimeters may be necessary.

Also the number of particles, i.e. particle density per an area unit, applied on the membrane affects the friction. Preferably, the number of particles should not be too large not to affect the hydraulic properties of the membrane. There are gaps and open spaces between the solid particles that expose the microporous membrane and allow a normal functioning of the membrane. The normal membrane surface (i.e. the spaces) covers majority of the membrane surface (e.g. 70-95%). In exemplary embodiments, an average particle density may be in the range approximately 50 . . . 250 particles/square centimeter (cm2). It should be appreciated that the local particle density may vary over the surface of the filter plate. For example, a minimum density counted may be 158 particles/cm2, a maximum density 226 particles/cm2, and an average density 182 particles/cm2. The appearance of the textured surface 50 with such particle density is illustrated in FIGS. 5B and 5C. An appropriate particle density may be selected dependent on the application where the filter plates are used. The particle size and the particle density are interrelated, thus selection of one may affect the selection of the other.

Another aspect of the invention is a method for manufacturing a filter element, such as a filter plate 22, to be used in removal of liquid from solids containing material to be dried in a capillary suction dryer, such as in a rotary vacuum disc filter 10. The filter element or filter plate 22 may comprise a ceramic microporous membrane layer 31 supported by a ceramic substrate 32, e.g. as discusses with reference to FIGS. 2, 3A, 3B and 3C above.

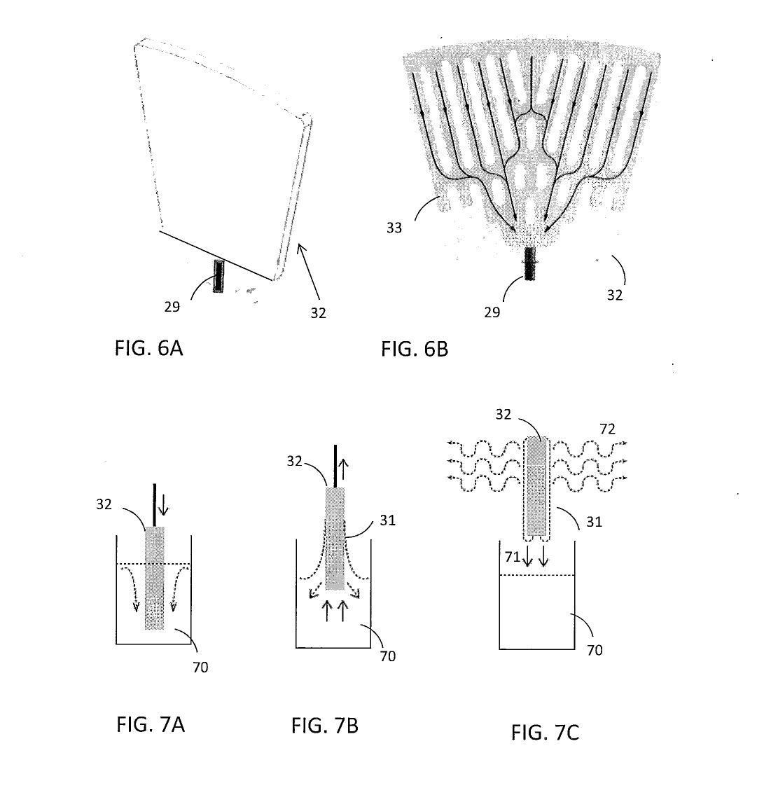

In an embodiment, when manufacturing the ceramic filter element the internal layer is first formed of at least one ceramic substrate 32. The ceramic substrate may be manufactured with any suitable manufacturing technique. The substrate may be made of a ceramic material in a powder form, such as for instance alumina and titania. The ceramic material may be mixed with a binding medium and liquid so that the ceramic mix formed and the core material for desired recess areas or filtrate channels can be charged into a mold. The material in the mold is then pressed into a green body. After pressing, the green body may be sintered at a high temperature, e.g. in a temperature range of 800-1600 degrees Celsius. Thereby, an integral ceramic substrate, so called monobody plate, may be formed in a single mold. The core material forming the recess areas or filtrate channels may comprise, for example, granular core material which allows a flow of the filtrate. As another example, the core material forming the recess areas may be burnt out through the porous structure of ceramic mix during the sintering. As a result, the substrate contains the open recess areas or open filtrate channels in a shape of the core material. FIG. 6A illustrates a monobody substrate 32 according to an exemplary embodiment which may be manufactured by mold pressing as described above. FIG. 6B illustrates a cross-sectional top view of a monobody substrate with the filtrate channels or recessed areas 33 exposed.

In an embodiment, the substrate of the filter plate 22 may be made of half-plates and glued together. Each half-plate may be manufactured by mold pressing, for example.

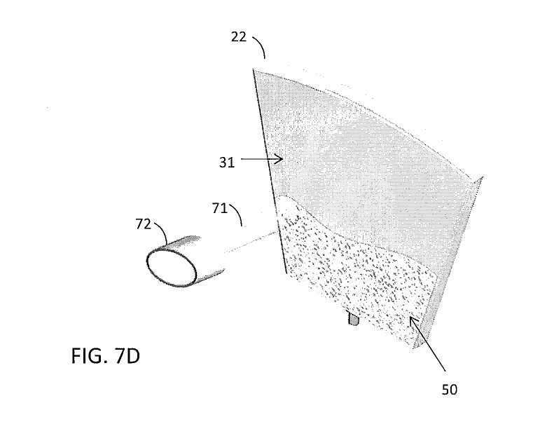

In an embodiment, a ceramic microporous membrane layer 31 may be produced on the ceramic substrate 32 by a dip coating process, an example of which is illustrated in FIGS. 7A, 7B and 7C. In a dip coating process, the substrate 32 is immersed in the suspension of the membrane material slurry 70, preferably at a constant speed (FIG. 7A). When the substrate 32 has remained inside the membranes material slurry 70 for a while, it is pulled up from the substrate sludge 70, preferably at a constant speed. A thin layer of the microporous membrane material 31 deposits itself on the substrate 32 while the substrate is pulled up (FIG. 7B). During the pull-up, excess membrane material slurry will drain 71 from the surface. The suspending fluid evaporates 72 from the microporous membrane material 31, forming the thin layer (FIG. 7C). The thickness of the membrane layer 31 may be about 1 millimeter, for example.

In another exemplary embodiment, a ceramic microporous membrane layer 31 may be produced on the ceramic substrate 32 by spraying.

To this point, the manufacturing of the filter plate 22 may be similar to that of a conventional filter plate. Normally, after the membrane layer 31 would have dried after the dip coating or spraying or other coating method, the substrate 32 coated with the membrane 31 would have been fired and sintered at a high temperature, e.g. in a temperature range of 1150-1550 degrees Celsius, resulting in the final filter plate.

However, in exemplary embodiments of the invention, solid particles are applied on the membrane material layer 31 after the dip coating or spraying or other coating method and prior to the firing or sintering. The solid particles which provide a textured surface 50 may be applied by spraying 71 (with a suitable spraying tool 72, e.g. a compressed-air paint spray gun) the solid particles on the membrane surface 31 (e.g. grit spraying process) immediately after the membrane dip coating as illustrated in FIG. 7D. The membrane 31 may have dried a bit but is preferably still moist before the spraying because the sprayed particles hit and readily stick to the moist membrane surface 31. The filter plate 22 may preferably be in an upright position during the spraying. The spraying may be carried out at a constant distance from the membrane surface 31. The spray 71 is preferably moved at a constant speed along the membrane surface 31 such that the number of particles hitting the membrane surface 31 is maintained in a desired range per area unit. For disc filter plates the particle spraying is performed on both sides of the filter plate 22. When the membrane layer 31 has dried after the particle spraying, the substrate 32 coated with the membrane 31 and the solid particles will be fired and sintered at a high temperature, e.g. in a temperature range of 1150-1550 degrees Celsius, resulting in the final filter plate. During the drying and firing the sprayed particles are well fixed and sintered the membrane surface 31 to establish the coarse texture 50.

It should be appreciated that the term “sintering” as used herein refers also to otherwise heating in a kiln to a high temperature to achieve fusion of a secondary bonding phase, i.e. a silica-rich phase.

Although example embodiments of filter plates for rotary vacuum disc filters have been illustrated above, the principles of the invention can be applied also for filter media of other types of vacuum filters, such as rotary vacuum drum filters.

In further embodiments, solid particles may be applied with some other methods than the spraying, such as particle spreading, adding the particles to the membrane slurry which is used for making the microporous membrane 31, etc. In the case the coarse solid particles are applied by adding them into the membrane sludge, the particle will be distributed throughout the entire thickness of membrane. However the spraying method is easier to control in production so that the particle density is in the desired range and the particle applying does not change the membrane properties or does not destroy the membrane locally, like some abrasive methods, for making the surface rough, such as sand-blasting, might do.

Upon reading the present application, it will be obvious to a person skilled in the art that the inventive concept can be implemented in various ways. The invention and its embodiments are not limited to the examples described above but may vary within the spirit and scope of the claims.

1. A method for manufacturing a filter element to be used in removal of liquid from solids containing material to be dried in a capillary suction dryer which filter element contains a ceramic microporous membrane layer supported by a ceramic substrate, wherein the method comprises:
providing the ceramic substrate,
coating the ceramic substrate by a ceramic microporous membrane material layer,
applying solid particles to the membrane material layer, a particle size of the solid particles being larger than a pore size of the membrane material layer, and
sintering the ceramic microporous membrane material containing the solid particles.

2. A method according to the claim 1, wherein the coating comprises dipping the ceramic substrate into a ceramic slurry to form the microporous ceramic membrane material layer.

3. A method according to the claim 1, wherein the applying comprises spraying the solid particles on the ceramic microporous layer.

4. A method according to the claim 2, wherein the applying comprises spraying the solid particles on the ceramic microporous layer.

5. A method according to claim 1, wherein setting the particle size of the solid particles and/or a desired particle density on the membrane material according to a desired friction effect.

6. A method according to claim 2, wherein setting the particle size of the solid particles and/or a desired particle density on the membrane material according to a desired friction effect.

7. A method according to claim 3, wherein setting the particle size of the solid particles and/or a desired particle density on the membrane material according to a desired friction effect.

8. A method according to claim 1, wherein the particle size is in the range of 10 micrometers . . . 800 micrometers, preferably in the range of 40 . . . 300 micrometers.

9. A method according to claim 2, wherein the particle size is in the range of 10 micrometers . . . 800 micrometers, preferably in the range of 40 . . . 300 micrometers.

10. A method according to claim 3, wherein the particle size is in the range of 10 micrometers . . . 800 micrometers, preferably in the range of 40 . . . 300 micrometers.

11. A method according to claim 1, wherein an average particle density on the membrane material is in the range approximately 50 . . . 250 particles/square centimeter.

12. A method according to claim 2, wherein an average particle density on the membrane material is in the range approximately 50 . . . 250 particles/square centimeter.

13. A method according to claim 8, wherein an average particle density on the membrane material is in the range approximately 50 . . . 250 particles/square centimeter.

14. A method according to claim 1, wherein the solid particles comprise alumina particles.

15. A filter element to be used in removal of liquid from solids containing material to be dried in a capillary suction dryer, the filter element comprising a ceramic substrate covered by a sintered ceramic microporous layer, wherein the sintered microporous membrane layer contains coarse solid particles of a particle size larger than a pore size of the membrane material layer.

16. A filter element according to claim 15, wherein the solid particles comprise alumina particles.

17. A filter element according to claim 15, wherein the particle size is in the range of approximately 10 micrometers . . . 800 micrometers, preferably in the range of approximately 40 . . . 300 micrometers.

18. A filter element according to claim 15, wherein an average particle density on the membrane material is in the range of approximately 50 . . . 250 particles/square centimeter.

19. A filter element according to claim 17, wherein an average particle density on the membrane material is in the range of approximately 50 . . . 250 particles/square centimeter.

20. A filter apparatus, comprising one or more filter elements, each filter element further comprising a ceramic substrate covered by a sintered ceramic microporous layer, wherein the sintered microporous membrane layer contains coarse solid particles of a particle size larger than a pore size of the membrane material layer.
